(19) United States
(12) Patent Application Publication
(10) Pub. No.: US 2026/0016690 A1
(43) Pub. Date: Jan. 15, 2026

(54) HEAD-UP DISPLAY AND HEAD-UP DISPLAY SYSTEM FOR TRANSPORTATION

(71) Applicant: CARUX TECHNOLOGY PTE. LTD., SINGAPORE (SG)

(72) Inventors: Yu-Hsuan Hsiao, Tainan (TW); Chun-Yi Kuo, Tainan (TW); Szu-Yen Yu, Tainan (TW); Yen-Liang Chen, Tainan (TW)

(73) Assignee: CARUX TECHNOLOGY PTE. LTD., SINGAPORE (SG)

(21) Appl. No.: 19/232,888

(22) Filed: Jun. 10, 2025

Related U.S. Application Data
(60) Provisional application No. 63/670,142, filed on Jul. 12, 2024.

(30) Foreign Application Priority Data
Mar. 19, 2025 (CN) 202510328294.9

(51) Int. Cl. G02B 27/01; B60K 35/23

(52) U.S. Cl. CPC G02B 27/0101; B60K 35/23; B60K 2360/20; G02B 2027/0112; G02B 2027/0118

(57) ABSTRACT

A head-up display and a head-up display system for a transportation. The head-up display is configured to display a first image. The first image is projected to form a second image. The head-up display includes a substrate and multiple light-emitting units disposed on the substrate. A first light-emitting unit and a second light-emitting unit of the light-emitting units respectively correspond to a first region and a second region of the first image. A third region and a fourth region of the second image respectively correspond to the first region and the second region of the first image. A configuration of the first light-emitting unit is different from a configuration of the second light-emitting unit, such that a chromaticity difference between the third region and the fourth region of the second image is less than a chromaticity difference between the first region and the second region of the first image.

### CROSS-REFERENCE TO RELATED APPLICATION

This application claims the priority benefit of U.S. provisional application Ser. No. 63/670,142, filed on Jul. 12, 2024 and China application serial no. 202510328294.9, filed on Mar. 19, 2025. The entirety of each of the above-mentioned patent applications is hereby incorporated by reference herein and made a part of this specification.

### BACKGROUND

### Technical Field

The disclosure relates to a head-up display and a head-up display system for a transportation.

### Description of Related Art

A head-up display system for a transportation may reduce risks of a driver being distracted while driving. At the same time, the head-up display system has advantages such as a small size or a large projection range. However, current head-up display systems have some issues to be solved. For example, regional chromaticity differences exist in a displayed image, negatively affecting driving experience.

### SUMMARY

The disclosure provides a head-up display and a head-up display system for a transportation, which may improve a driving experience.

According to an embodiment of the disclosure, a head-up display is configured to display a first image. The first image is projected to form a second image. The head-up display includes a substrate and multiple light-emitting units disposed on the substrate. A first light-emitting unit and a second light-emitting unit of the light-emitting units respectively correspond to a first region and a second region of the first image. A third region and a fourth region of the second image respectively correspond to the first region and the second region of the first image. A configuration of the first light-emitting unit is different from a configuration of the second light-emitting unit, such that a chromaticity difference between the third region and the fourth region of the second image is less than a chromaticity difference between the first region and the second region of the first image.

According to an embodiment of the disclosure, a head-up display system for a transportation includes a display and a windshield. The display is configured to display a first image and includes a substrate and multiple light-emitting units disposed on the substrate. A first light-emitting unit and a second light-emitting unit of the light-emitting units respectively correspond to a first region and a second region of the first image. The windshield is disposed adjacent to the display. The first image is projected onto the windshield and forms a second image. A third region and a fourth region of the second image respectively correspond to the first region and the second region of the first image. A configuration of the first light-emitting unit is different from a configuration of the second light-emitting unit, such that a chromaticity difference between the third region and the fourth region of the second image is less than a chromaticity difference between the first region and the second region of the first image.

To make the features and advantages of the disclosure more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of a head-up display system according to some embodiments of the disclosure.

FIG. 2 is a top-view schematic diagram of the display in FIG. 1.

FIG. 3 and FIG. 4 are two cross-sectional schematic diagrams respectively corresponding to cross-sectional line I-I′ in FIG. 2.

FIG. 5 is a partial cross-sectional schematic diagram of a display according to some embodiments of the disclosure.

FIGS. 6 to 8 are respectively top-view schematic diagrams of three types of displays according to some embodiments of the disclosure.

FIG. 9 is a partial cross-sectional schematic diagram of a display according to some embodiments of the disclosure.

FIGS. 10 to 15 are respectively top-view schematic diagrams of six types of displays according to some embodiments of the disclosure.

### DESCRIPTION OF THE EMBODIMENTS

Reference will now be made in detail to the exemplary embodiments of the disclosure, examples of which are illustrated in the accompanying drawings. Wherever possible, the same reference numbers are used in the drawings and the description to refer to the same or like parts.

Throughout the specification and appended claims of the disclosure, certain terms are used to refer to specific elements. A person having ordinary skill in the art should understand that electronic device manufacturers might refer to identical elements by different names. The disclosure herein does not intend to distinguish between elements that have identical functions but different names. In the following specification and claims, terms such as “contain” and “comprise” are open-ended terms, and therefore should be interpreted to mean “contain but not limited to . . . ”.

Directional terms used herein, for example, “up”, “down”, “front”, “rear”, “left”, “right”, etc., merely refer to the directions in the accompanying figures. Therefore, the directional terms used are intended for illustration and not intended to limit the disclosure. In the drawings, each figure shows general characteristics of methods, structures, and/or materials used in specific embodiments. However, these drawings should not be interpreted to define or limit the scope or nature covered by these embodiments. For example, for clarity, relative dimensions, thicknesses, and positions of various layers, regions, and/or structures may be reduced or enlarged.

In the disclosure, one structure (or layer, element, substrate) described as located on/above another structure (or layer, element, substrate) may refer to two structures being adjacent and directly connected, or it may refer to two structures being adjacent but not directly connected. Non-direct connection means there is at least one intermediary structure (or intermediary layer, intermediary element, intermediary substrate, intermediary space) between the two structures, wherein a lower surface of one structure is adjacent or directly connected to an upper surface of the intermediary structure, and an upper surface of the other structure is adjacent or directly connected to a lower surface of the intermediary structure. The intermediary structure may be composed of a single-layer or multi-layer solid or non-solid structure without limitation. In the disclosure, when a structure is disposed “on” other structures, it may mean that the structure is “directly” on the other structures, or it may mean the structure is “indirectly” on the other structures, that is, at least one structure is disposed between the structure and the other structures.

The terms “about,” “substantially,” or “approximately” are generally interpreted as within 10% of a given value or range, or interpreted as within 5%, 3%, 2%, 1%, or 0.5% of a given value or range. Furthermore, the terms “ranging from a first value to a second value,” or “ranging between a first value and a second value,” indicate that the stated range includes the first value, the second value, and other values therebetween.

Ordinal numbers used in the specification and claims, such as “first,” “second,” and so forth, are used to modify elements. The ordinal numbers themselves do not imply or represent any prior ordinal number for the element(s), nor do they represent a sequence between one element and another element, or a sequence in the manufacturing method. The use of these ordinal numbers is solely for clearly distinguishing an element having a certain name from another element having the same name. The same terminology may not necessarily be used in the claims and the specification; accordingly, a first component in the specification may be a second component in the claims.

Electrical connection or coupling described in the disclosure may refer to either direct connection or indirect connection. In the case of direct connection, endpoints of elements on two circuits are directly connected or connected to each other by a conductive wire segment. In the case of indirect connection, there are switches, diodes, capacitors, inductors, resistors, other suitable elements, or combinations of the above-mentioned elements between endpoints of elements on two circuits, but is not limited thereto.

In the disclosure, the measurement methods for thickness, length, and width may be performed by using an optical microscope (OM), and thickness or width may also be measured by cross-sectional images from an electron microscope, but is not limited thereto. Additionally, any two values or directions used for comparison may have certain errors. Furthermore, the terms “a given range is from a first value to a second value,” “a given range falls within a range of a first value to a second value,” or “a given range is between a first value and a second value,” indicate that the given range includes the first value, the second value, and other values therebetween. If a first direction is perpendicular to a second direction, an angle between the first direction and the second direction may range between 80 degrees to 100 degrees. If a first direction is parallel to a second direction, an angle between the first direction and the second direction may range between 0 degrees to 10 degrees.

Unless otherwise defined, all terms used herein (including technical and scientific terms) have the same meanings as commonly understood by persons skilled in the technical field to which the disclosure belongs. It is understood that these terms, for example terms defined in commonly used dictionaries, should be interpreted as having meanings consistent with the related technology and the background or context of the disclosure, and should not be interpreted in an idealized or overly formal manner unless specifically defined in embodiments of the disclosure.

In the disclosure, an electronic device may include a light-emitting device, a display device, a backlight device, an antenna device, a package device, a sensing device, or a splicing device, but is not limited thereto. The electronic device may be a bendable or flexible electronic device. The display device may be a non-self-luminous type display device or a self-luminous type display device. The display device may include, for example, liquid crystal, light-emitting diode, fluorescence, phosphor, quantum dot (QD), other suitable display media, or a combination thereof. The antenna device may, for example, include a reconfigurable intelligent surface (RIS), frequency selective surface (FSS), RF-filter, polarizer, resonator, or antenna, etc. The antenna may be a liquid crystal-type antenna or a varactor diode antenna. The sensing device may be a device sensing capacitance, light, thermal energy, or ultrasound, but is not limited thereto. In the disclosure, the electronic device may include electronic elements. The electronic elements may include passive elements and active elements, such as capacitors, resistors, inductors, diodes, transistors, etc. The diode may include a light-emitting diode, varactor diode, or photodiode. The light-emitting diode may include, for example, an organic light emitting diode (OLED), a mini LED, a micro LED, or a quantum dot LED, but is not limited thereto. The splicing device may be, for example, a display splicing device or an antenna splicing device, but is not limited thereto. It should be noted that the electronic device may be any permutation and combination of the foregoing, but is not limited thereto. The package device may be suitable for wafer-level package (WLP) technology or panel-level package (PLP) technology, such as a package device of a chip first process or a chip last process. In addition, a shape of the electronic device may be rectangular, circular, polygonal, having curved edges, or other suitable shapes. The electronic device may have peripheral systems such as a driving system, a control system, and a light-source system to support the display device, antenna device, wearable device (for example including augmented reality or virtual reality), vehicle-mounted device (for example including automobile windshield), or splicing device.

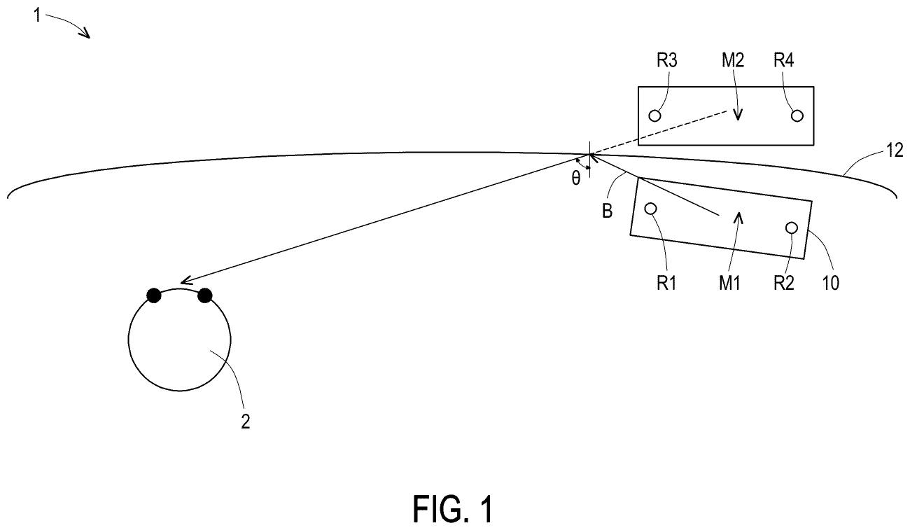

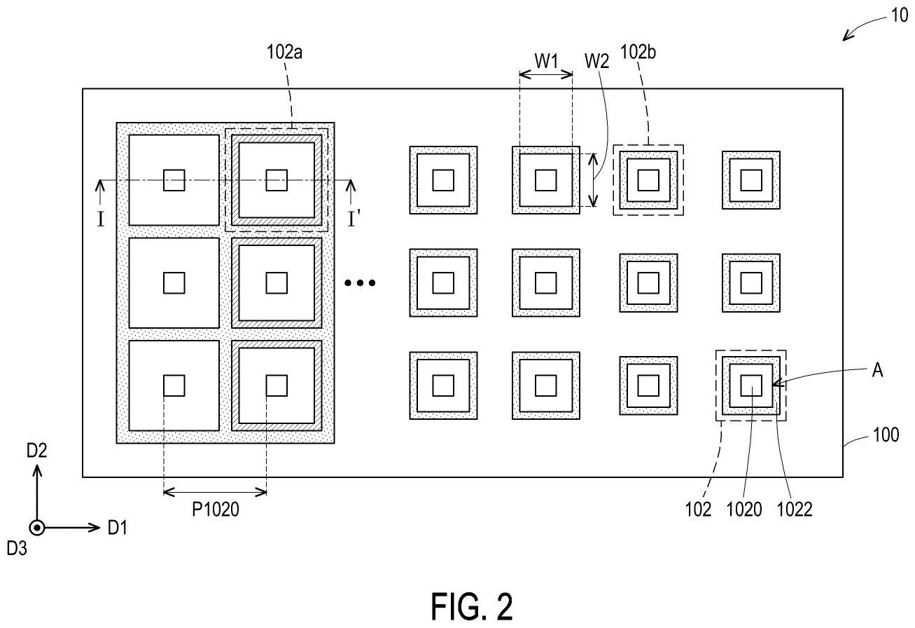

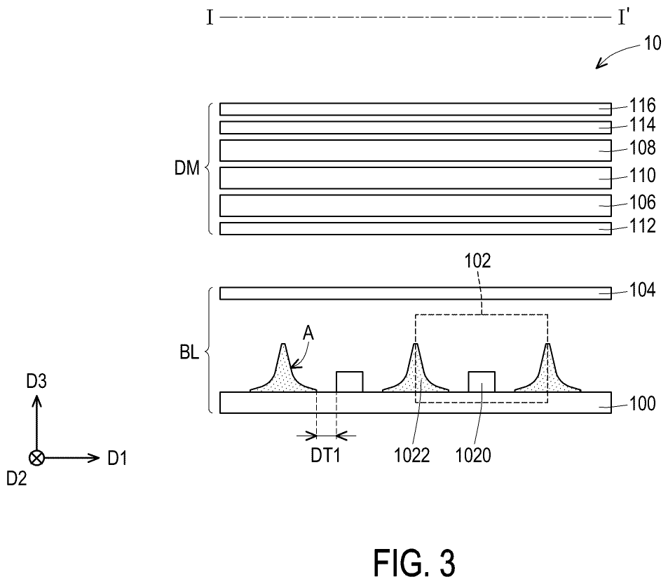

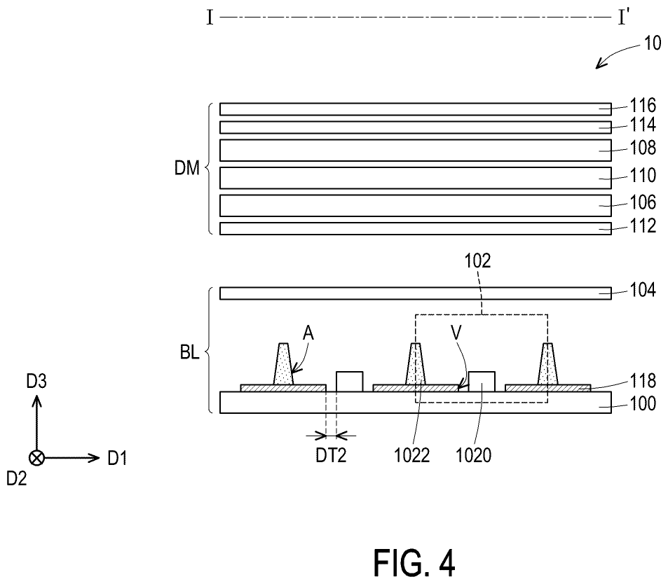

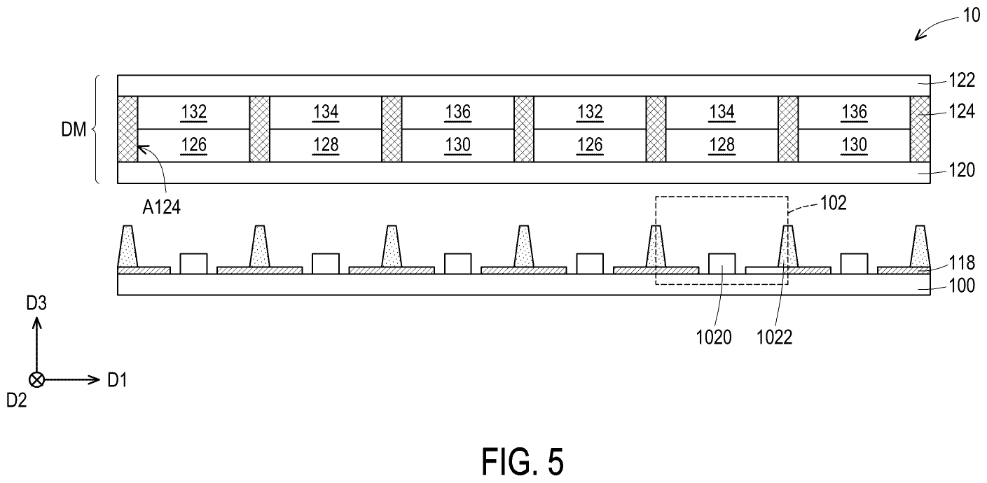

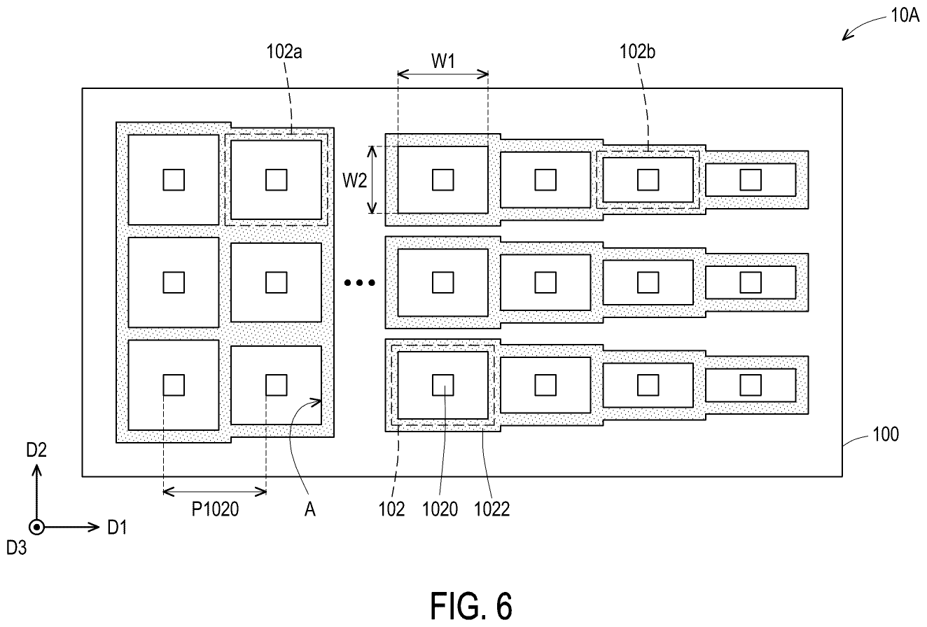

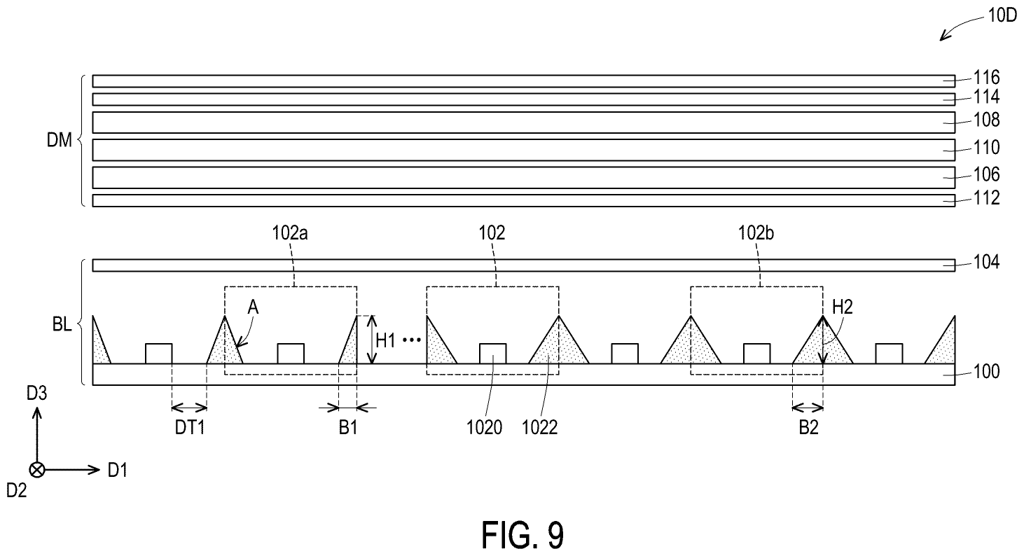

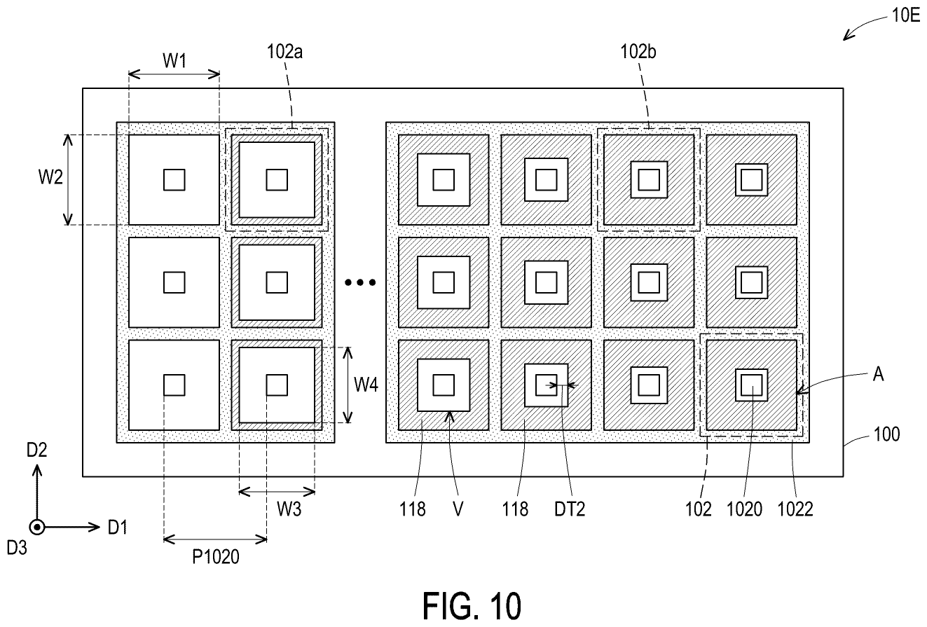

FIG. 1 is a schematic diagram of a head-up display system according to some embodiments of the disclosure. FIG. 2 is a top-view schematic diagram of the display in FIG. 1. FIG. 3 and FIG. 4 are two cross-sectional schematic diagrams respectively corresponding to cross-sectional line I-I′ in FIG. 2. FIG. 5 is a partial cross-sectional schematic diagram of a display according to some embodiments of the disclosure. FIGS. 6 to 8 are respectively top-view schematic diagrams of three types of displays according to some embodiments of the disclosure. FIG. 9 is a partial cross-sectional schematic diagram of a display according to some embodiments of the disclosure. FIGS. 10 to 15 are respectively top-view schematic diagrams of six types of displays according to some embodiments of the disclosure.

In the above top-view schematic diagrams, certain elements and/or layers in the displays are omitted to clearly illustrate the relative arrangement of specific elements, and elements and/or layers omitted in the top-view schematic diagrams may be referred to in the cross-sectional schematic diagrams. It should further be understood that, in the embodiments described below, features from several different embodiments may be replaced, recombined, and mixed to complete other embodiments without departing from the spirit of the disclosure. Features from various embodiments may be arbitrarily combined and matched as long as the combinations do not violate the spirit of the disclosure or conflict with each other.

Referring first to FIG. 1 and FIG. 2, a head-up display system 1 for a transportation may include a display 10 and a windshield 12. The display 10 is configured to display a first image M1 and includes a substrate 100 and multiple light-emitting units 102 disposed on the substrate 100, wherein a first light-emitting unit 102a and a second light-emitting unit 102b of the light-emitting units 102 respectively correspond to a first region R1 and a second region R2 of the first image M1. The windshield 12 is disposed adjacent to the display 10. The first image M1 is projected onto the windshield 12 and forms a second image M2. A third region R3 and a fourth region R4 of the second image M2 respectively correspond to the first region R1 and the second region R2 of the first image M1. A configuration of the first light-emitting unit 102a is different from a configuration of the second light-emitting unit 102b, such that a chromaticity difference between the third region R3 and the fourth region R4 of the second image M2 is less than a chromaticity difference between the first region R1 and the second region R2 of the first image M1.

Specifically, the head-up display system 1 may be integrated with a system in a transportation to form a vehicle-mounted system, but is not limited thereto. A type of the transportation is not limited. In terms of power, the transportation may be a fuel vehicle (for example, gasoline vehicle or diesel vehicle), a hybrid vehicle, or an electric vehicle, but is not limited thereto. In terms of appearance or function, the transportation may be a sedan, a recreational vehicle, a sports car, a truck, a bus, a military vehicle, a racing car, a special vehicle, a construction vehicle, or a camper van, but is not limited thereto.

The display 10 in the head-up display system 1 may be a head-up display and may be configured to display a first image M1. An image beam B carrying information of the first image M1 may be projected onto the windshield 12 via the display 10. The image beam B is reflected by the windshield 12 and transmitted to the eyes of a driver 2, allowing the driver 2 to see a second image M2 (for example, magnified virtual image) corresponding to the first image M1 in front of the driver 2.

The substrate 100 in the display 10 may be a circuit board or a carrier board having circuits formed thereon. The carrier board may be a rigid carrier board or a flexible carrier board. A material of the carrier board may include, for example, glass, quartz, ceramic, sapphire, or plastic, but is not limited thereto. Plastic may include polycarbonate (PC), polyimide (PI), polypropylene (PP), polyethylene terephthalate (PET), other suitable flexible materials, or combinations of the foregoing materials, but is not limited thereto. Furthermore, a transmittance of the carrier board is not limited, that is, the carrier board may be a transparent substrate, a semi-transparent substrate, or a non-transparent substrate.

The light-emitting units 102 in the display 10 are disposed on the substrate 100 and electrically connected to the substrate 100. In some embodiments, as shown in FIG. 2, each of the light-emitting units 102 (for example, each of the first light-emitting unit 102a and the second light-emitting unit 102b) may include a light-emitting element 1020 and a retaining wall 1022 surrounding the light-emitting element 1020.

The light-emitting element 1020 includes, for example, a light-emitting diode, such as an organic light-emitting diode, a mini LED, a micro LED, or a quantum dot LED, but is not limited thereto. In some embodiments, as shown in FIG. 2, the light-emitting elements 1020 may be arranged into an array along a direction D1 and a direction D2. The direction D1 and the direction D2 are both perpendicular to a thickness direction of the display 10 (for example, a direction D3), wherein the direction D1 is, for example, parallel to an arrangement direction of the first light-emitting unit 102a and the second light-emitting unit 102b, and the direction D2 intersects the direction D1. In some embodiments, as shown in FIG. 2, the direction D1 and the direction D2 may be perpendicular to each other.

The retaining wall 1022 surrounding the light-emitting element 1020 may be used to reflect a light beam. In some embodiments, the retaining wall 1022 may have a reflectivity for visible light (for example, light having wavelengths in a range of 400 nm to 700 nm) greater than or equal to 70%, for example, in a range of 75% to 85%, in a range of 85% to 95%, or greater than or equal to 94%, but is not limited thereto. For example, a material of the retaining wall 1022 may include plastic, reflective film, or silicone, and a method for fabricating the retaining wall 1022 may include 3D printing, liquid injection process, or extrusion molding process, but is not limited thereto.

The retaining wall 1022 may include an opening A accommodating the light-emitting element 1020, and the less a size of the opening A of the retaining wall 1022 (for example, a width W1 of the opening A in the direction D1 and/or a width W2 of the opening A in the direction D2) is, the more yellowish the image becomes. In some embodiments, by varying sizes of the openings A in the light-emitting units 102, the light-emitting units 102 may have different configurations. Taking FIG. 2 as an example, sizes of the openings A in the light-emitting units 102 may gradually change along the direction D1 (for example, gradually become less along the direction D1), such that in a top view, a size of the opening A of the retaining wall 1022 of the second light-emitting unit 102b is different from (less than) a size of the opening A of the retaining wall 1022 of the first light-emitting unit 102a. In some embodiments, as shown in FIG. 2, a pitch P1020 of the light-emitting elements 1020 in the direction D1 is a fixed value, and a width W1 of the opening A in the direction D1 may be less than or equal to the pitch P1020 of the light-emitting elements 1020 in the direction D1.

Specifically, a reflection spectrum of a multi-layer film structure (for example, a glass

structure, a heat-insulating layer, etc.) of the windshield 12 shifts toward shorter wavelengths (blue shift) as a reflection angle θ increases, causing the reflected image to appear more bluish to the human eye when the reflection angle is greater. Taking FIG. 1 as an example, under a structure in which the second region R2 of the first image M1 is located farther away from the driver 2 than the first region R1, an image beam from the second region R2 is transmitted to the eyes of the driver 2 at a greater reflection angle θ than an image beam from the first region R1. Thus, according to the aforementioned phenomenon that the image undergoes blue shift as the reflection angle θ increases, even when the first region R1 and the second region R2 of the first image M1 display the same chromaticity, a chromaticity of the fourth region R4 in the second image M2 perceived by the driver 2 becomes more bluish than a chromaticity of the third region R3 in the second image M2.

In this specification, chromaticity compensation for different regions of the first image M1 is performed by adjusting configurations of the light-emitting units 102, thereby improving chromaticity consistency between different regions of the second image M2 and reducing a driving risk caused by a driver's misjudgment of color. Taking FIG. 2 as an example, adjusting configurations of the light-emitting units 102 may include adjusting sizes of the openings A of the retaining walls 1022 of the light-emitting units 102. Specifically, by making a size of the opening A of the retaining wall 1022 of the second light-emitting unit 102b less than a size of the opening

A of the retaining wall 1022 of the first light-emitting unit 102a, a chromaticity of the second region R2 of the first image M1 becomes more yellowish than a chromaticity of the first region

R1, thereby compensating for the aforementioned phenomenon of image blue shift caused by an increase of the reflection angle θ and improving chromaticity consistency between the third region R3 and the fourth region R4 of the second image M2. Taking a CIE1931 color space as an example, if color coordinates of the first region R1 are (x1, y1) and color coordinates of the second region R2 are (x2, y2), chromaticity compensation may be performed by making x1<x2 and y1<y2. In some embodiments, chromaticity consistency of the third region R3 and the fourth region R4 generally refers to a color-coordinate difference between the third region R3 and the fourth region R4 being less than 0.01 under a pure color image (for example, a white image, a red image, a green image, or a blue image), such as |x2−x1|<0.01 and/or |y2−y1|<0.01.

A method for measuring chromaticities of different regions may include measuring chromaticities of different regions under a pure color image. For example, the display 10 may display a pure color image (for example, a white image or a red image), and then a spectrum measuring instrument (for example, CA-310, DMS, CS-2000, and SR-3) is fixed at a central position between the driver's two eyes to capture the first region R1 of the first image M1, the second region R2 of the first image M1, the third region R3 of the second image M2, and the fourth region R4 of the second image M2 to obtain four spectra corresponding to the above-mentioned four regions. Then, the four spectra are converted into color coordinates to perform chromaticity comparison. Alternatively, a reflection spectrum of the windshield 12 and a spectrum of the display 10 may be measured, and then the reflection spectrum of the windshield 12 is multiplied by the spectrum of the display 10, followed by conversion into color coordinates for chromaticity comparison. Alternatively, a camera or charge-coupled device (CCD) may be used to capture an image photo, then analyze chromaticities in the photo, and subsequently compare the chromaticities.

For convenience of illustration, FIG. 1 takes a left-hand drive as an example, but it should be understood that the design concept of the disclosure is also applicable to a right-hand drive. In an embodiment of the right-hand drive, although not shown, the second region R2 is closer to the driver 2 than the first region R1, and a size of the opening of the retaining wall of the first light-emitting unit may be made less than a size of the opening of the retaining wall of the second light-emitting unit, causing a chromaticity of the first region R1 of the first image M1 to become more yellowish than a chromaticity of the second region R2, thereby improving chromaticity consistency between different regions of the second image M2.

In embodiments of the disclosure, the display 10 may use a non-self-luminous display or a self-luminous display, such as a liquid crystal display, a light-emitting diode (LED) display, an organic light emitting diode (OLED) display, a fluorescence display, or a phosphor display, but is not limited thereto. The liquid crystal display may include a thin-film transistor display, but is not limited thereto. The light-emitting diode may include, for example, an inorganic light-emitting diode, a mini LED, a micro LED, or a quantum dot LED (QLED, QDLED), or other suitable materials or any permutation and combination of the foregoing, but is not limited thereto. Furthermore, a shape of the display 10 may be rectangular, circular, polygonal, having curved edges, or other suitable shapes.

When the display 10 uses a non-self-luminous display, as shown in FIG. 3, the display 10 may include a backlight module BL and a display module DM disposed on a light-exiting side of the backlight module BL. The backlight module BL may include the aforementioned substrate 100 and the light-emitting units 102. The light-emitting element 1020 of the light-emitting unit 102, for example, may be a light-emitting diode emitting white light, but is not limited thereto.

In some embodiments, as shown in FIG. 3, the retaining wall 1022 is, for example, a retaining wall injection-molded by plastic (for example, PC). Considering injection molding processes and assembly tolerances, a shortest distance DT1 between the light-emitting element 1020 and the retaining wall 1022 is, for example, in a range of 0.4 mm to 0.8 mm, that is, 0.4 mm≤DT1≤0.8 mm, but is not limited thereto.

In some embodiments, as shown in FIG. 3, the backlight module BL may further include at least one optical film 104. The optical film 104 may include a diffusion sheet, a prism sheet, a brightness-enhancing film, other types of optical films, or combinations thereof.

The display module DM, for example, may be a liquid crystal display module, and the display module DM may include a lower substrate 106, an upper substrate 108, a liquid crystal layer 110, a lower polarizer 112, an upper polarizer 114, and a cover plate 116, but is not limited thereto. According to different requirements, the display module DM may further include other elements or film layers, such as a pixel electrode layer, a common electrode layer, and/or a touch layer.

The lower substrate 106 and the upper substrate 108 are relative to each other, and the liquid crystal layer 110 is disposed between the lower substrate 106 and the upper substrate 108. The lower substrate 106 and the upper substrate 108 may be rigid substrates or flexible substrates. A material of the lower substrate 106 and the upper substrate 108 may include, for example, glass, quartz, ceramic, sapphire, or plastic, but is not limited thereto. Plastic may include PC, PI, PP, PET, other suitable flexible materials, or combinations of the foregoing materials, but is not limited thereto. A type of liquid crystal in the liquid crystal layer 110 may not be limited.

The lower polarizer 112 is disposed on a surface of the lower substrate 106 away from the upper substrate 108, and the upper polarizer 114 is disposed on a surface of the upper substrate 108 away from the lower substrate 106. The lower polarizer 112 and the upper polarizer 114 may have absorption axes perpendicular or parallel to each other.

The cover plate 116 is disposed on a surface of the upper polarizer 114 away from the lower substrate 106. A material of the cover plate 116 may include, for example, glass, quartz, ceramic, sapphire, or plastic, but is not limited thereto.

In some other embodiments, as shown in FIG. 4, at least one of the light-emitting units 102 (for example, each of the first light-emitting unit 102a and the second light-emitting unit 102b) may further include a reflective unit 118 disposed between the retaining wall 1022 and the substrate 100, wherein the reflective unit 118 includes a through via V, and the light-emitting element 1020 is disposed in the through via V. Considering brightness, processes, and assembly tolerances, a shortest distance DT2 between a sidewall of the through via V and the light-emitting element 1020 may be, for example, in a range of 0 mm to 0.4 mm, that is, 0 mm≤DT2≤0.4 mm, but is not limited thereto. The reflective unit 118 may include a white reflective film or a silicone reflective layer, but is not limited thereto. The retaining wall 1022 is disposed on the reflective unit 118, and the retaining wall 1022 may be a film-compression molded retaining wall, but is not limited thereto. Alternatively, the retaining wall 1022 disposed on the reflective unit 118 may be an injection-molded or glue-dispensed retaining wall. The reflective unit 118 and the retaining wall 1022 may be made of identical or different materials, and a reflectivity of the reflective unit 118 for visible light may be greater than 92%, but is not limited thereto. Each embodiment of the disclosure may selectively include the reflective unit 118, which is not repeated below.

Optionally, the display 10 may also employ a self-luminous display. When the display 10 employs the self-luminous display, as shown in FIG. 5, in addition to the aforementioned substrate 100 and the light-emitting units 102, the display 10 may further include a light conversion module CM disposed on the light-emitting units 102. The light conversion module CM includes, for example, a lower substrate 120, an upper substrate 122, a light shielding layer 124, multiple first color conversion patterns 126, multiple second color conversion patterns 128, multiple filling patterns 130, multiple first filtering patterns 132, multiple second filtering patterns 134, and multiple third filtering patterns 136, but is not limited thereto. According to different requirements, the light conversion module CM may further include other elements or film layers.

The lower substrate 120 and the upper substrate 122 are relative to each other, and the light shielding layer 124 is disposed between the lower substrate 120 and the upper substrate 122. The lower substrate 120 and the upper substrate 122 may be rigid substrates or flexible substrates. A material of the lower substrate 120 and the upper substrate 122 may include, for example, glass, quartz, ceramic, sapphire, or plastic, but is not limited thereto. Plastic may include PC, PI, PP, PET, other suitable flexible materials, or combinations of the foregoing materials, but is not limited thereto. The light shielding layer 124 may be single-layered or multi-layered, and the light shielding layer 124 may include opaque organic polymer material to reduce issues such as interference and/or light mixing between adjacent light-emitting units 102. The opaque organic polymer material may be white, gray, or black organic polymer material, such as a black matrix, but is not limited thereto.

The light shielding layer 124 has multiple openings A124. Each opening A124 at least partially overlaps with a corresponding light-emitting unit 102, allowing the light emitted from the light-emitting unit 102 to pass through. The first color conversion patterns 126, the second color conversion patterns 128, and the filling patterns 130 are disposed on the lower substrate 120 and respectively located in the openings A124. For example, the first color conversion patterns 126, the second color conversion patterns 128, and the filling patterns 130 are alternately arranged along the direction D1, and the first color conversion patterns 126 and the second color conversion patterns 128 are, for example, a red light conversion layer and a green light conversion layer, respectively. Materials of the first color conversion patterns 126 and the second color conversion patterns 128 may include fluorescence, phosphor, quantum dot (QD), other suitable materials, or combinations of at least the foregoing. Materials of the filling patterns 130 may be transparent materials to allow the light (for example, blue light) emitted from the light-emitting units 102 to pass through. Optionally, materials of the filling patterns 130 may further include light scattering particles.

The first filtering patterns 132, the second filtering patterns 134, and the third filtering patterns 136 are respectively located in the openings A124 and respectively disposed on the first color conversion patterns 126, the second color conversion patterns 128, and the filling patterns 130. For example, the first filtering patterns 132, the second filtering patterns 134, and the third filtering patterns 136 are respectively multiple red filtering patterns, multiple green filtering patterns, and multiple blue filtering patterns, but are not limited thereto.

Referring to FIG. 6, a display 10A may also be a head-up display. A main difference between the display 10A and the display 10 in FIG. 2 is that, in the display 10A, a width W1 of the opening A of the retaining wall 1022 in the direction D1 is a fixed value, while a width W2 of the opening A of the retaining wall 1022 in the direction D2 gradually decreases along the direction D1, for example.

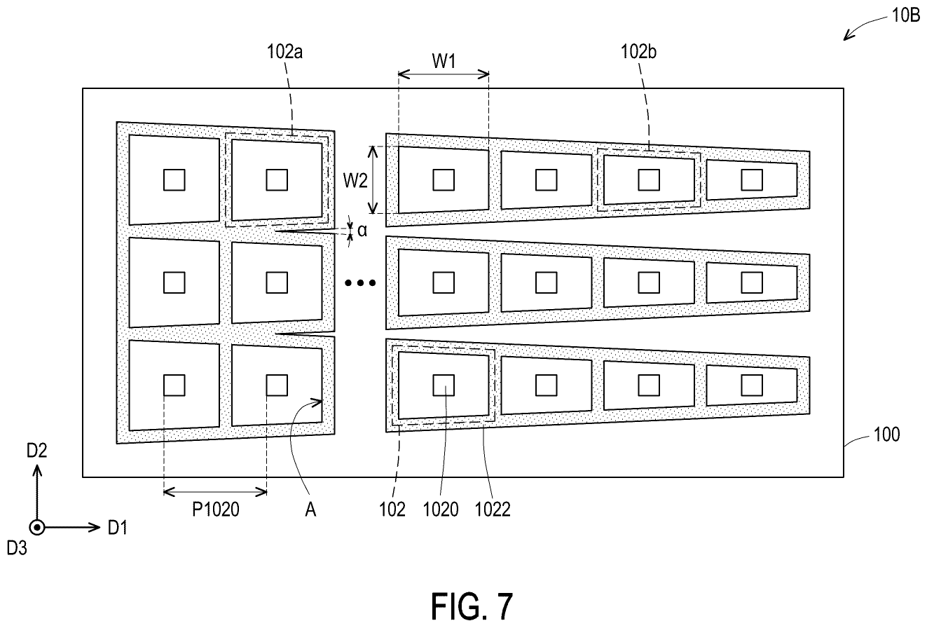

Referring to FIG. 7, a display 10B may also be a head-up display. A main difference between the display 10B and the display 10A in FIG. 6 is that a top-view shape of the opening A of the retaining wall 1022 of the display 10A is rectangular, while a top-view shape of the opening A of the retaining wall 1022 of the display 10B is trapezoidal. Specifically, in the light-emitting units 102 in FIG. 7, the retaining walls 1022 arranged along the direction D1 have different lengths, and the retaining walls 1022 arranged along the direction D2 have identical lengths. In some embodiments, an included angle α between two adjacent retaining walls 1022 of two adjacent light-emitting units 102 in the direction D2 is, for example, within a range of 10 degrees to 60 degrees, making the retaining walls 1022 easier to manufacture. For example, the included angle α may be 15 degrees, 20 degrees, 25 degrees, 30 degrees, 40 degrees, 45 degrees, 50 degrees, or 55 degrees, but is not limited thereto.

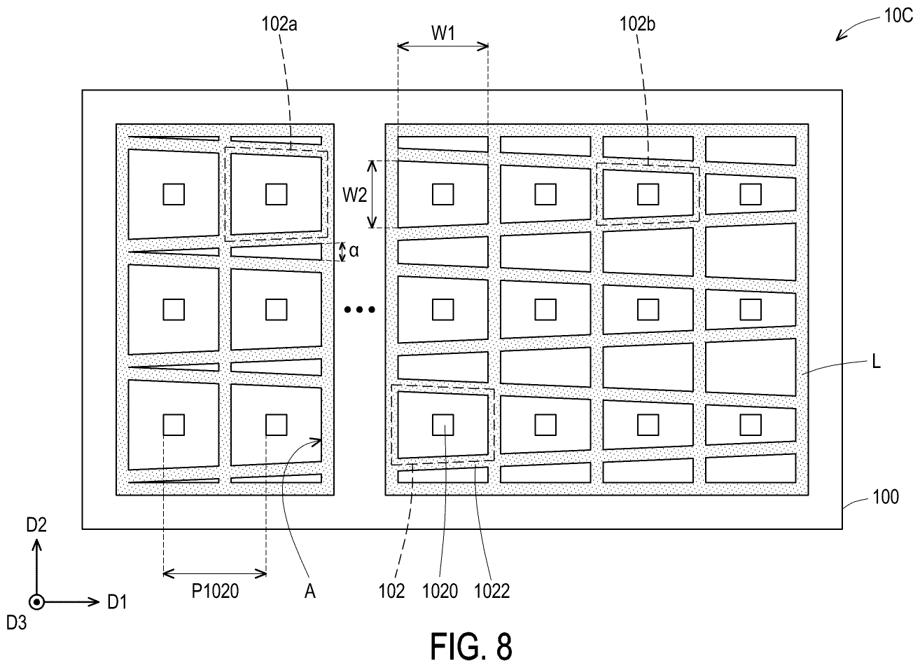

Referring to FIG. 8, a display 10C may also be a head-up display. A main difference between the display 10C and the display 10B in FIG. 7 is that, in the display 10C, two adjacent retaining walls 1022 of two adjacent light-emitting units 102 in the direction D2 are connected to each other through a grid line L. The grid line L and the retaining walls 1022 may have identical materials and may be fabricated together.

Referring to FIG. 9, a display 10D may also be a head-up display. A main difference between the display 10D and the display 10 in FIG. 3 is that the display 10D adjusts configurations of the light-emitting units 102 by adjusting slopes of the retaining walls 1022 in the light-emitting units 102. The slope of the retaining wall 1022 refers to a bottom width of the retaining wall 1022 divided by a height of the retaining wall 1022 in a cross-sectional diagram. Under a structure in which adjacent retaining walls 1022 of adjacent light-emitting units 102 are connected to each other to form an integrated structure (which may also be regarded as adjacent light-emitting units 102 sharing a single retaining wall structure), as shown in a triangular retaining wall structure in FIG. 9, a vertical line segment may be drawn from a highest point of the integrated structure toward the substrate 100, serving as a boundary between adjacent retaining walls 1022 of adjacent light-emitting units 102. A bottom width of the retaining wall 1022 is, for example, a shortest distance from the boundary to an inner edge of the retaining wall 1022 in the cross-sectional diagram, and a height of the retaining wall 1022 is, for example, a shortest distance from the highest point of the integrated structure to a bottom of the integrated structure. Taking FIG. 9 as an example, the slope of the retaining wall 1022 of the first light-emitting unit 102a is a bottom width B1 divided by a height H1, and the slope of the retaining wall 1022 of the second light-emitting unit 102b is a bottom width B2 divided by a height H2. In some embodiments, as shown in FIG. 9, the retaining walls 1022 in the light-emitting units 102 may have identical heights (i.e., H1=H2) and different bottom widths (i.e., B1/B2), such that, in the cross-sectional diagram, the slope of the retaining wall 1022 of the second light-emitting unit 102b is different from the slope of the retaining wall 1022 of the first light-emitting unit 102a. For example, the bottom width of the retaining wall 1022 may gradually decrease along the direction D1. Correspondingly, the shortest distance DT1 between the light-emitting element 1020 and the retaining wall 1022 may gradually decrease along the direction D1.

Utilizing a characteristic that the less the slope of the retaining wall 1022 is, the more yellowish the image becomes, chromaticity compensation for different regions of the first image may be performed by adjusting slopes of the retaining walls 1022 in the light-emitting units 102, thereby improving chromaticity consistency between different regions of the second image, and reducing a driving risk caused by a driver's misjudgment of color.

Referring to FIG. 10, a display 10E may also be a head-up display. A main difference between the display 10E and the display 10 in FIG. 2 and FIG. 4 is that the display 10E adjusts configurations of the light-emitting units 102 by adjusting sizes of the through vias V of the reflective units 118 in the light-emitting units 102.

Specifically, in the display 10E, a size of the opening A of the retaining wall 1022 (for example, a width W1 of the opening A in the direction D1 and/or a width W2 in the direction D2) is a fixed value, while a size of the through via V of the reflective unit 118 (for example, a width W3 of the through via V in the direction D1 and/or a width W4 of the through via V in the direction D2) gradually decreases along the direction D1, such that, in a top view, a size of the through via V in the second light-emitting unit 102b is different from (less than) a size of the through via V in the first light-emitting unit 102a.

A reflectivity of the reflective unit 118 for visible light is, for example, greater than 92%, and a reflectivity of the substrate 100 for visible light is, for example, less than 92%. Utilizing a characteristic that the less the size of the through via V is, the more yellowish the image becomes, chromaticity compensation for different regions of the first image may be performed by adjusting sizes of the through vias V of the reflective units 118 in the light-emitting units 102, thereby improving chromaticity consistency between different regions of the second image, and reducing a driving risk caused by a driver's misjudgment of color.

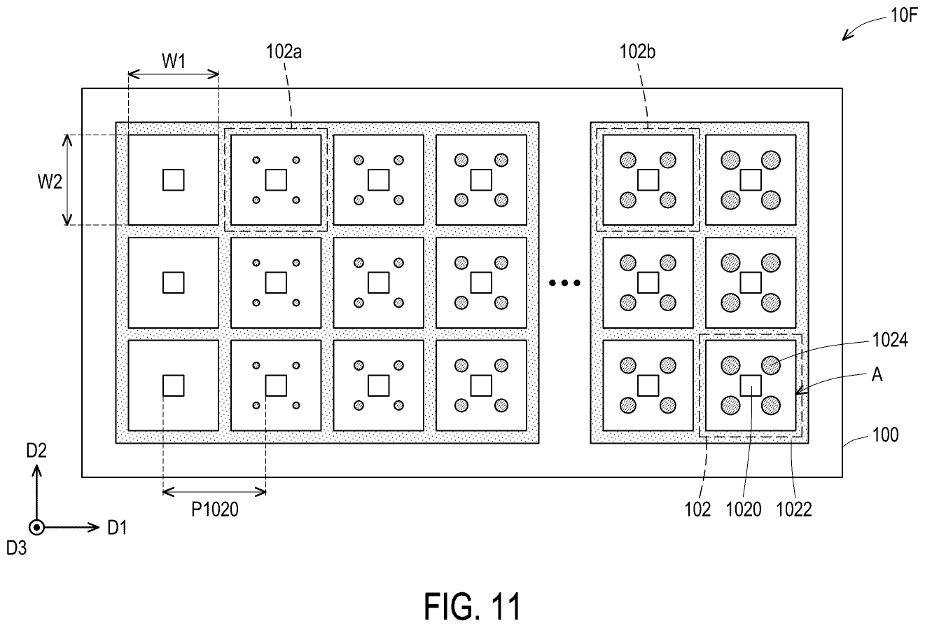

Referring to FIG. 11, a display 10F may also be a head-up display. A main difference between the display 10F and the display 10E in FIG. 10 is that the display 10F adjusts configurations of the light-emitting units 102 by adjusting sizes of multiple dimming patterns 1024 in the light-emitting units 102.

Specifically, in the display 10F, at least one of the light-emitting units 102 (for example, each of the first light-emitting unit 102a and the second light-emitting unit 102b) further includes a dimming pattern 1024 disposed between the retaining wall 1022 and the light-emitting element 1020, and a color of the dimming pattern 1024 is different from a color of a light beam emitted from the light-emitting element 1020. For example, the color of the light beam emitted from the light-emitting element 1020 may be blue or white, and the color of the dimming pattern 1024 may be yellow, and the dimming pattern 1024 may convert the blue or white light emitted from the light-emitting element 1020 into yellow light, but is not limited thereto. A material of the dimming pattern 1024 may include fluorescence, phosphor, quantum dot (QD), other suitable materials, or combinations of at least the foregoing.

In some embodiments, as shown in FIG. 11, a size of the dimming pattern 1024 gradually increases along the direction D1, such that a size of the dimming pattern 1024 of the second light-emitting unit 102b is different from (larger than) a size of the dimming pattern 1024 of the first light-emitting unit 102a. Utilizing a characteristic that the larger the size of the dimming pattern 1024 is, the more yellowish the image becomes, chromaticity compensation for different regions of the first image may be performed by adjusting sizes of the dimming patterns 1024 in the light-emitting units 102, thereby improving chromaticity consistency between different regions of the second image, and reducing a driving risk caused by a driver's misjudgment of color.

In some embodiments, although not shown in FIG. 11, at least one of the light-emitting units 102 (for example, each of the first light-emitting unit 102a and the second light-emitting unit 102b) may further include the aforementioned reflective unit 118, and in the light-emitting unit 102 provided with the reflective unit 118, the dimming patterns 1024 may be disposed on the reflective unit 118. For example, under the structure in FIG. 5, the dimming pattern 1024 may be disposed on the reflective unit 118 and located between the retaining wall 1022 and the light-emitting element 1020.

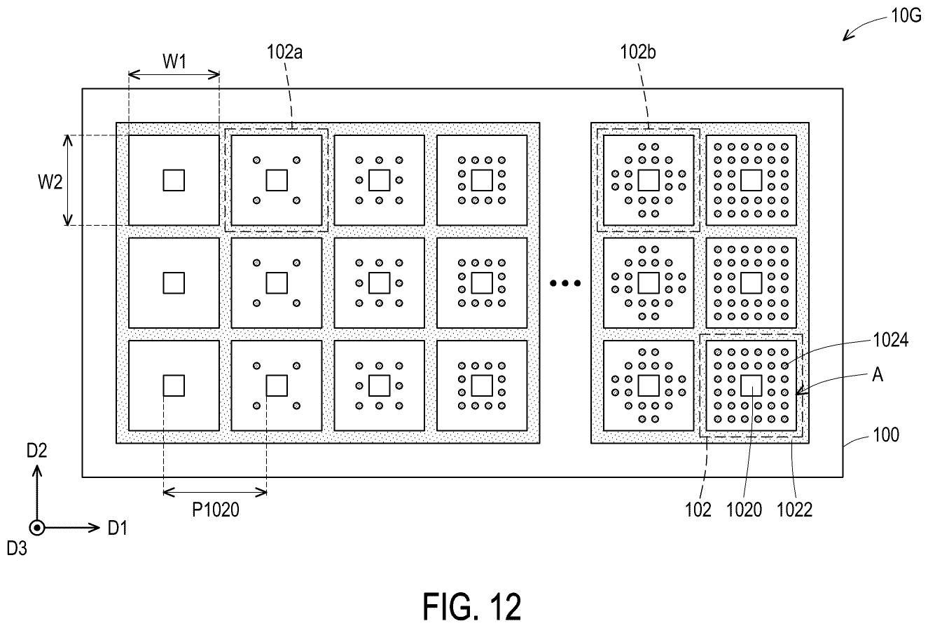

Referring to FIG. 12, a display 10G may also be a head-up display. A main difference between the display 10G and the display 10F in FIG. 11 is that the display 10G adjusts configurations of the light-emitting units 102 by adjusting densities of the dimming patterns 1024 in the light-emitting units 102.

Specifically, in the display 10G, a size of the dimming pattern 1024 may be a fixed value, and a density of the dimming pattern 1024 gradually increases along the direction D1, such that a density of the dimming pattern 1024 of the second light-emitting unit 102b is different from (greater than) a density of the dimming pattern 1024 of the first light-emitting unit 102a. Utilizing a characteristic that the greater the density of the dimming pattern 1024 is, the more yellowish the image becomes, chromaticity compensation for different regions of the first image may be performed by adjusting densities of the dimming patterns 1024 in the light-emitting units 102, thereby improving chromaticity consistency between different regions of the second image, and reducing a driving risk caused by a driver's misjudgment of color.

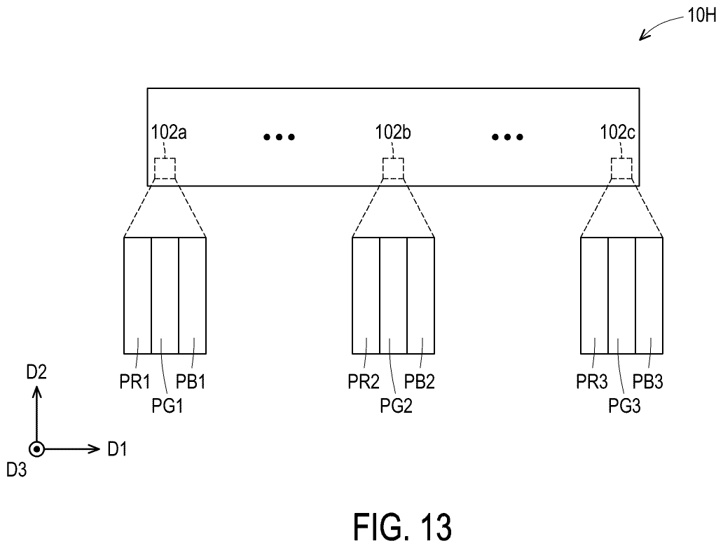

Referring to FIG. 13, a display 10H may also be a head-up display. The display 10H adjusts configurations of the light-emitting units, for example, by adjusting maximum currents of multiple light-emitting elements of the same color in the light-emitting units.

Specifically, the display 10H is, for example, a self-luminous display, wherein the first light-emitting unit 102a includes a first light-emitting element (for example, a first blue light-emitting element PB1), the second light-emitting unit 102b includes a second light-emitting element (for example, a second blue light-emitting element PB2), the first light-emitting element and the second light-emitting element are light-emitting elements of the same color, and a maximum current of the first light-emitting element is different from a maximum current of the second light-emitting element. Utilizing a characteristic that the greater the maximum current of the blue light-emitting element is, the more bluish the image becomes, chromaticity compensation for different regions of the first image may be performed by adjusting maximum currents of multiple blue light-emitting elements in the light-emitting units, thereby improving chromaticity consistency between different regions of the second image, and reducing a driving risk caused by a driver's misjudgment of color.

FIG. 13 schematically illustrates the first light-emitting unit 102a, the second light-emitting unit 102b, and the third light-emitting unit 102c sequentially arranged along the direction D1. The first light-emitting unit 102a includes, for example, a first red light-emitting element PR1, a first green light-emitting element PG1, and a first blue light-emitting element PB1. The second light-emitting unit 102b includes, for example, a second red light-emitting element PR2, a second green light-emitting element PG2, and a second blue light-emitting element PB2. The third light-emitting unit 102c includes, for example, a third red light-emitting element PR3, a third green light-emitting element PG3, and a third blue light-emitting element PB3.

In some embodiments, the first red light-emitting element PR1, the first green light-emitting element PG1, the first blue light-emitting element PB1, the second red light-emitting element PR2, the second green light-emitting element PG2, the second blue light-emitting element PB2, the third red light-emitting element PR3, the third green light-emitting element PG3, and the third blue light-emitting element PB3 have identical light-emitting areas. In addition, light-emitting elements of the same color in different light-emitting units may have different maximum currents.

For example, a maximum current of the first red light-emitting element PR1 may be less than a maximum current of the second red light-emitting element PR2, and the maximum current of the second red light-emitting element PR2 may be less than a maximum current of the third red light-emitting element PR3; a maximum current of the first green light-emitting element PG1 may be less than a maximum current of the second green light-emitting element PG2, and the maximum current of the second green light-emitting element PG2 may be less than a maximum current of the third green light-emitting element PG3; a maximum current of the first blue light-emitting element PB1 may be greater than a maximum current of the second blue light-emitting element PB2, and the maximum current of the second blue light-emitting element PB2 may be greater than a maximum current of the third blue light-emitting element PB3. As an example, the maximum current of the first red light-emitting element PR1, the maximum current of the second red light-emitting element PR2, and the maximum current of the third red light-emitting element PR3 may be 50%, 75%, and 95% of a maximum threshold current, respectively; the maximum current of the first green light-emitting element PG1, the maximum current of the second green light-emitting element PG2, and the maximum current of the third green light-emitting element PG3 may be 55%, 80%, and 95% of the maximum threshold current, respectively; the maximum current of the first blue light-emitting element PB1, the maximum current of the second blue light-emitting element PB2, and the maximum current of the third blue light-emitting element PB3 may be 95%, 90%, and 85% of the maximum threshold current, respectively, but are not limited thereto.

Alternatively, the display 10H may be a non-self-luminous display, such as a liquid crystal display. Although not shown, the first light-emitting unit 102a may include a first red sub-pixel, a first green sub-pixel, and a first blue sub-pixel; the second light-emitting unit 102b may include a second red sub-pixel, a second green sub-pixel, and a second blue sub-pixel; the third light-emitting unit 102c may include a third red sub-pixel, a third green sub-pixel, and a third blue sub-pixel. A gray level of each sub-pixel may be changed by adjusting a maximum voltage applied to a pixel electrode of the sub-pixel. For example, gray-level values of the first red sub-pixel, the second red sub-pixel, and the third red sub-pixel may be respectively 50%, 75%, and 95% of a maximum gray-level value; the first green sub-pixel, the second green sub-pixel, and the third green sub-pixel may be respectively 55%, 80%, and 95% of the maximum gray-level value; the first blue sub-pixel, the second blue sub-pixel, and the third blue sub-pixel may be respectively 95%, 90%, and 85% of the maximum gray-level value, but are not limited thereto.

Chromaticity compensation for different regions of the first image may be performed by adjusting the maximum voltages of the sub-pixels, thereby improving chromaticity consistency between different regions of the second image and reducing a driving risk caused by a driver's misjudgment of color.

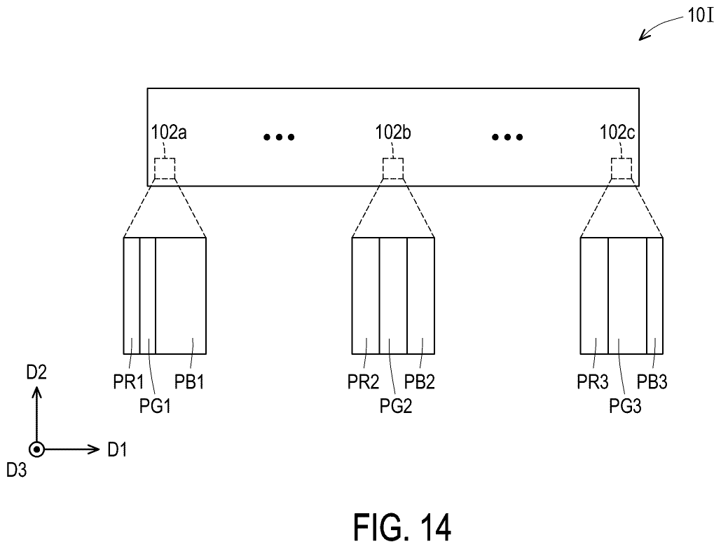

Referring to FIG. 14, a display 10I may also be a head-up display. A main difference between the display 10I and the display 10H in FIG. 13 is that the display 10I adjusts configurations of the light-emitting units by adjusting light-emitting areas of the light-emitting elements of the same color in the light-emitting units. For example, in the display 10I, a light-emitting area of a first light-emitting element (for example, a first blue light-emitting element PB1) is different from a light-emitting area of a second light-emitting element (for example, a second blue light-emitting element PB2). Utilizing a characteristic that the greater the light-emitting area of a blue light-emitting element is, the more bluish the image becomes, chromaticity compensation for different regions of the first image may be performed by adjusting light-emitting areas of multiple blue light-emitting elements in the light-emitting units, thereby improving chromaticity consistency between different regions of the second image, and reducing a driving risk caused by a driver's misjudgment of color.

Specifically, light-emitting elements of the same color in different light-emitting units may have identical maximum currents and different light-emitting areas. For example, a light-emitting area of the first red light-emitting element PR1 may be less than a light-emitting area of the second red light-emitting element PR2, and the light-emitting area of the second red light-emitting element PR2 may be less than a light-emitting area of the third red light-emitting element PR3; a light-emitting area of the first green light-emitting element PG1 may be less than a light-emitting area of the second green light-emitting element PG2, and the light-emitting area of the second green light-emitting element PG2 may be less than a light-emitting area of the third green light-emitting element PG3; a light-emitting area of the first blue light-emitting element PB1 may be greater than a light-emitting area of the second blue light-emitting element PB2, and the light-emitting area of the second blue light-emitting element PB2 may be greater than a light-emitting area of the third blue light-emitting element PB3.

Alternatively, the display 10I may be a non-self-luminous display, such as a liquid crystal display, wherein an aperture ratio of a first red sub-pixel of the first light-emitting unit 102a may be less than an aperture ratio of a second red sub-pixel of the second light-emitting unit 102b, and the aperture ratio of the second red sub-pixel of the second light-emitting unit 102b may be less than an aperture ratio of a third red sub-pixel of the third light-emitting unit 102c; an aperture ratio of a first green sub-pixel of the first light-emitting unit 102a may be less than an aperture ratio of a second green sub-pixel of the second light-emitting unit 102b, and the aperture ratio of the second green sub-pixel of the second light-emitting unit 102b may be less than an aperture ratio of a third green sub-pixel of the third light-emitting unit 102c; an aperture ratio of a first blue sub-pixel of the first light-emitting unit 102a may be greater than an aperture ratio of a second blue sub-pixel of the second light-emitting unit 102b, and the aperture ratio of the second blue sub-pixel of the second light-emitting unit 102b may be greater than an aperture ratio of a third blue sub-pixel of the third light-emitting unit 102c.

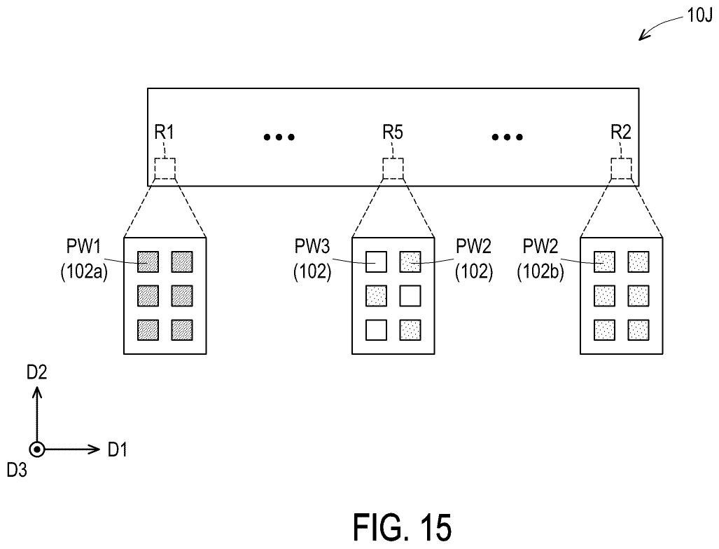

Referring to FIG. 15, a display 10J may also be a head-up display. A main difference between the display 10J and the display 10I in FIG. 14 is that the display 10J adjusts configurations of the light-emitting units by adjusting chromaticities of the light-emitting elements of the same color in the light-emitting units. For example, in the display 10J, a chromaticity of a first light-emitting element (for example, a first white light-emitting element PW1) is different from a chromaticity of a second light-emitting element (for example, a second white light-emitting element PW2).

Specifically, the display 10J may be a self-luminous display. FIG. 15 schematically illustrates the first region R1, a fifth region R5, and the second region R2 sequentially arranged along the direction D1, wherein the first region R1, the fifth region R5, and the second region R2 may each be provided with multiple white light-emitting elements. For example, the first region R1 is provided with multiple first white light-emitting elements PW1, the second region R2 is provided with multiple second white light-emitting elements PW2, and the fifth region R5 is provided with multiple second white light-emitting elements PW2 and multiple third white light-emitting elements PW3, wherein the second white light-emitting elements PW2 and the third white light-emitting elements PW3 in the fifth region R5 are alternately arranged along the direction D1 and the direction D2. The first white light-emitting elements PW1, for example, are white light-emitting elements having chromaticities shifted toward blue, the second white light-emitting elements PW2, for example, are white light-emitting elements having chromaticities shifted toward yellow, and the third white light-emitting elements PW3, for example, are white light-emitting elements having chromaticities shifted toward green. In other embodiments, the third white light-emitting elements PW3 in the fifth region R5 may also be replaced with the first white light-emitting elements PW1.

By adjusting chromaticities of the white light-emitting elements in the light-emitting units to perform chromaticity compensation for different regions of the first image (for example, the farther away from the driver a region is, the more yellowish the chromaticity of the white light-emitting elements becomes, and the closer to the driver a region is, the more bluish the chromaticity of the white light-emitting elements becomes), chromaticity consistency between different regions of the second image may be improved, thereby reducing a driving risk caused by a driver's misjudgment of color.

In summary, in the embodiments of the disclosure, chromaticity compensation for different regions of the first image may be performed by adjusting configurations of the light-emitting units, thereby improving chromaticity consistency between different regions of the second image and reducing a driving risk caused by a driver's misjudgment of color.

The above embodiments are only used to illustrate the technical solutions of the disclosure and are not intended to limit the disclosure. Although the disclosure has been described in detail with reference to the foregoing embodiments, those skilled in the art should understand that modifications may still be made to the technical solutions described in the foregoing embodiments, or some or all of the technical features may be replaced with equivalents. These modifications or replacements do not cause the essence of the corresponding technical solutions to deviate from the scope of the technical solutions in the embodiments of the disclosure.

Although embodiments of the disclosure and advantages thereof have been described above, it should be understood that persons skilled in the art may make modifications, substitutions, and refinements without departing from the spirit and scope of the disclosure, and features among different embodiments may be mixed and substituted arbitrarily to form other new embodiments. Furthermore, a protection scope of the disclosure is not limited to the processes, machines, manufacturing, compositions of matter, devices, methods, and steps described in specific embodiments within the specification. Persons skilled in the art may appreciate that currently available or future developed processes, machines, manufacturing, compositions of matter, devices, methods, and steps revealed by the disclosure may be used according to the disclosure, as long as substantially the same functions or substantially the same results of the embodiments described herein may be achieved. Therefore, the protection scope of the disclosure includes the aforementioned processes, machines, manufacturing, compositions of matter, devices, methods, and steps. Moreover, each claim constitutes an individual embodiment, and the protection scope of the disclosure also includes combinations of each claim and embodiments. The protection scope of the disclosure shall be defined by the appended claims.

What is claimed is:

1. A head-up display, configured to display a first image, wherein the first image is projected to form a second image, the head-up display comprising:
a substrate; and
a plurality of light-emitting units, disposed on the substrate, wherein:
a first light-emitting unit and a second light-emitting unit of the plurality of light-emitting units respectively correspond to a first region and a second region of the first image,
a third region and a fourth region of the second image respectively correspond to the first region and the second region of the first image, and
a configuration of the first light-emitting unit is different from a configuration of the second light-emitting unit, such that a chromaticity difference between the third region and the fourth region of the second image is less than a chromaticity difference between the first region and the second region of the first image.

2. The head-up display according to claim 1, wherein each of the first light-emitting unit and the second light-emitting unit comprises a light-emitting element and a retaining wall surrounding the light-emitting element.

3. The head-up display according to claim 2, wherein, in a top view, a size of an opening of the retaining wall of the second light-emitting unit is different from a size of an opening of the retaining wall of the first light-emitting unit.

4. The head-up display according to claim 2, wherein, in a cross-sectional view, a slope of the retaining wall of the second light-emitting unit is different from a slope of the retaining wall of the first light-emitting unit.

5. The head-up display according to claim 2, wherein the each of the first light-emitting unit and the second light-emitting unit further comprises a reflective unit, disposed between the retaining wall and the substrate, wherein the reflective unit comprises a through via, and the light-emitting element is disposed in the through via.

6. The head-up display according to claim 5, wherein, in a top view, a size of the through via in the second light-emitting unit is different from a size of the through via in the first light-emitting unit.

7. The head-up display according to claim 2, wherein the each of the first light-emitting unit and the second light-emitting unit further comprises a dimming pattern, disposed between the retaining wall and the light-emitting element, a color of the dimming pattern being different from a color of a light beam emitted from the light-emitting element.

8. The head-up display according to claim 7, wherein a density of the dimming pattern of the second light-emitting unit is different from a density of the dimming pattern of the first light-emitting unit.

9. The head-up display according to claim 7, wherein a size of the dimming pattern of the second light-emitting unit is different from a size of the dimming pattern of the first light-emitting unit.

10. The head-up display according to claim 1, wherein the first light-emitting unit comprises a first light-emitting element, the second light-emitting unit comprises a second light-emitting element, and the first light-emitting element and the second light-emitting element are light-emitting elements of a same color, wherein:
a maximum current of the first light-emitting element is different from a maximum current of the second light-emitting element;
a light-emitting area of the first light-emitting element is different from a light-emitting area of the second light-emitting element; or
a chromaticity of the first light-emitting element is different from a chromaticity of the second light-emitting element.

11. A head-up display system for a transportation, comprising:
a display, configured to display a first image and comprising a substrate and a plurality of light-emitting units disposed on the substrate, wherein a first light-emitting unit and a second light-emitting unit of the plurality of light-emitting units respectively correspond to a first region and a second region of the first image; and
a windshield, disposed adjacent to the display, wherein:
the first image is projected onto the windshield and forms a second image, and a third region and a fourth region of the second image respectively correspond to the first region and the second region of the first image, and
a configuration of the first light-emitting unit is different from a configuration of the second light-emitting unit, such that a chromaticity difference between the third region and the fourth region of the second image is less than a chromaticity difference between the first region and the second region of the first image.

12. The head-up display system for the transportation according to claim 11, wherein each of the first light-emitting unit and the second light-emitting unit comprises a light-emitting element and a retaining wall surrounding the light-emitting element.

13. The head-up display system for the transportation according to claim 12, wherein, in a top view, a size of an opening of the retaining wall of the second light-emitting unit is different from a size of an opening of the retaining wall of the first light-emitting unit.

14. The head-up display system for the transportation according to claim 12, wherein, in a cross-sectional view, a slope of the retaining wall of the second light-emitting unit is different from a slope of the retaining wall of the first light-emitting unit.

15. The head-up display system for the transportation according to claim 12, wherein the each of the first light-emitting unit and the second light-emitting unit further comprises a reflective unit, disposed between the retaining wall and the substrate, wherein the reflective unit comprises a through via, and the light-emitting element is disposed in the through via.

16. The head-up display system for the transportation according to claim 15, wherein, in a top view, a size of the through via in the second light-emitting unit is different from a size of the through via in the first light-emitting unit.

17. The head-up display system for the transportation according to claim 12, wherein the each of the first light-emitting unit and the second light-emitting unit further comprises a dimming pattern, disposed between the retaining wall and the light-emitting element, a color of the dimming pattern being different from a color of a light beam emitted from the light-emitting element.

18. The head-up display system for the transportation according to claim 17, wherein a density of the dimming pattern of the second light-emitting unit is different from a density of the dimming pattern of the first light-emitting unit.

19. The head-up display system for the transportation according to claim 17, wherein a size of the dimming pattern of the second light-emitting unit is different from a size of the dimming pattern of the first light-emitting unit.

20. The head-up display system for the transportation according to claim 11, wherein the first light-emitting unit comprises a first light-emitting element, the second light-emitting unit comprises a second light-emitting element, and the first light-emitting element and the second light-emitting element are light-emitting elements of a same color, wherein:
a maximum current of the first light-emitting element is different from a maximum current of the second light-emitting element;
a light-emitting area of the first light-emitting element is different from a light-emitting area of the second light-emitting element; or
a chromaticity of the first light-emitting element is different from a chromaticity of the second light-emitting element.
